(19) United States
(12) Patent Application Publication
(10) Pub. No.: US 2026/0299339 A1
(43) Pub. Date: Oct. 1, 2026

(54) AUTO-DARKENING FILTER (ADF) AND CONTROL METHOD THEREOF

(71) Applicant: TECMEN ELECTRONICS CO., LTD, Nanjing, Jiangsu (CN)

(72) Inventors: Chengfa FAN, Nanjing (CN); Peng HU, Nanjing (CN)

(21) Appl. No.: 19/479,718

(22) PCT Filed: Dec. 8, 2023
(86) PCT No.: PCT/CN2023/137463

§ 371 Date: Oct. 28, 2025

(30) Foreign Application Priority Data
Apr. 28, 2023 (CN) 202310487625.4
Jun. 1, 2023 (CN) 202310643910.0

(51) Int. Cl. G02F 1/133; G02F 1/1347

(52) U.S. Cl. CPC G02F 1/13318; G02F 1/1347

(57) ABSTRACT

An auto-darkening filter (ADF) and a control method thereof. The ADF comprises: two positive liquid crystal sheets; a control device 106 configured to output a control signal of the operating mode 1 or operating mode 2 and an original liquid crystal control signal when the ADF is in an operating mode and any shading number in a shading number range corresponding to an operating mode 1 or operating mode 2 is scheduled to be used; a liquid crystal signal control circuit configured to generate a low-voltage high-frequency liquid crystal control signal and a first control voltage according to the control signal of the operating mode 1, or generate a high-voltage low-frequency liquid crystal control signal and a second control voltage according to the control signal of the operating mode 2; and a liquid crystal driving multiplexing circuit configured to receive the liquid crystal control signal and the control voltage and a modulatable driving voltage output by the control device, and generate a low-voltage high-frequency liquid crystal driving signal or a high-voltage low-frequency liquid crystal driving signal and output same to the two positive liquid crystal sheets.

### CROSS REFERENCE TO RELATED APPLICATIONS

This application is a 371 National Stage of International Application No. PCT/CN2023/137463, filed on Dec. 8, 2023, which claims priority to Chinese Invention Patent Application No. 202310487625.4, field on Apr. 28, 2023 and entitled “AUTO-DARKENING FILTER (ADF) AND CONTROL METHOD THEREOF” and Chinese Invention Patent Application No. 202310643910.0, field on Jun. 1, 2023 and entitled “AUTO-DARKENING FILTER (ADF) AND CONTROL METHOD THEREOF”, the disclosures of which are herein incorporated by reference in their entirety.

### TECHNICAL FIELD

The present disclosure relates to the field of photoelectric technologies, and particularly to an auto-darkening filter (ADF) with low costs and high shading numbers and a control method thereof, and in particular, to an auto-darkening filter (ADF) that can cover a shading number range of DIN4-13 and can provide shading numbers of DIN14-15 at low cost, and a control method thereof.

### BACKGROUND

In production operation of arc welding or oxy-fuel cutting, for generated electric arc light or intense flames, an auto-darkening filter (the ADF) using a liquid crystal light valve needs to be used to protect the eyes of an operator to avoid the harm from intense visible light. The ADF can provide the operator with a bright and clear field of view before arc striking, and a welding joint can be accurately positioned through the ADF. Once an arc is struck, the operator does not need to perform blocking manually, and the ADF can darken automatically and quickly, so that the intensity of visible light in the field of view of the operator is reduced, and ultraviolet rays and infrared rays in electric arc light can be effectively blocked, to prevent the eyes of the operator from burns.

An optical performance indicator of an ADF is a shading number. The shading number represents a transmission ratio level of a filter. According to the size of the shading number, the operator chooses a corresponding different ADF. Therefore, the accuracy of shading numbers greatly affects the quality of a welding product and the protection for the eyes of the operator. A shading number of a corresponding ADF is usually selected according to the magnitude of a current in welding. For example, in a TIG (non-consumable electrode inert gas protection arc welding) welding scenario, when a range of a current is 40A-350A, a required shading number range is DIN9-13. In some extreme scenarios such as heavy metal MIG (consumable electrode inert gas protection welding) welding or MAG (consumable electrode active gas protection arc welding) welding, etc., a current may reach 400-600 A. In this case, a required shading number at least needs to reach DIN14.

In a commonly used ADF with shading numbers of DIN4-13, a liquid crystal box with two positive liquid crystal sheets disposed on inner and outer sides with respect to the operator (i.e. a solution using two liquid crystal sheets) is used. Some ADFs with shading numbers of DIN14 and above usually use a liquid crystal box in which one intermediate liquid crystal sheet is added in addition to two positive liquid crystal sheets disposed on inner and outer sides (i.e. a solution using three liquid crystal sheets).

According to different application cases, in the solution using three liquid crystal sheets, the intermediate liquid crystal sheet may be a positive liquid crystal sheet or a negative liquid crystal sheet. In a solution using a negative intermediate liquid crystal sheet (i.e. a solution using three liquid crystal sheets comprising two positive liquid crystal sheets and one negative liquid crystal sheet), generally, when a shading number range is DIN11-13, power needs to be supplied to the negative intermediate liquid crystal sheet of the ADF to make the negative intermediate liquid crystal sheet keep a high light transmittance, and power is not supplied to the negative intermediate liquid crystal sheet only when the shading number is DIN14 or above (i.e. a high shading number). However, an operating time during which the shading number is high is relatively short. Therefore, the solution using three liquid crystal sheets comprising two positive liquid crystal sheets and one negative liquid crystal sheet increases the consumption of power of the ADF. In the solution using a positive intermediate liquid crystal sheet (i.e. a solution using three positive liquid crystal sheets), when the ADF is in a standby state and a shading number is DIN14 or above, power is not supplied to the three positive liquid crystal sheets. When the ADF is in an operating state and the shading number is any one of DIN4-8, power is supplied to two positive liquid crystal sheets disposed on inner and outer sides. When the shading number rises to DIN9 or above, power is supplied to the positive intermediate liquid crystal sheet. In the solution using three positive liquid crystal sheets, although the coverage of high shading numbers can be achieved, the positive intermediate liquid crystal sheet needs to be used when the shading number is DIN9 or above. Therefore, although the two solutions of three liquid crystal sheets in the prior art can provide coverage of a shading number range being DIN14 or above, because three liquid crystal sheets are used, the cost of the ADF is high, the size and weight of the ADF are large, and the power consumption of the ADF is increased.

Therefore, an implementation solution of an auto-darkening filter (ADF) with low cost, low power consumption, and high shading numbers coverage is required.

### SUMMARY

To solve the above problems in the prior art, an object of the present disclosure is to provide an auto-darkening filter (ADF) using two positive liquid crystal sheets and a control method thereof, so that the ADF can achieve the coverage of shading numbers of DIN14-15 (i.e. high shading numbers), and the cost, the size and the weight of the ADF are reduced, and the power consumption of the ADF in a high shading number case is reduced.

According to a first aspect of the present disclosure, an auto-darkening filter (ADF) is provided, the ADF comprises two positive liquid crystal sheets, a control device configured to output an original liquid crystal control signal and a modulatable driving voltage, and a liquid crystal control circuit configured to control the two positive liquid crystal sheets according to the original liquid crystal control signal received, wherein
the control device is further configured to enable a liquid crystal signal control mode 1 to output a control signal of the operating mode 1 and the original liquid crystal control signal when the ADF is in an operating mode and any shading number in a shading number range corresponding to an operating mode 1 is scheduled to be used, or enable a liquid crystal signal control mode 2 to output a control signal of the operating mode 2 and the original liquid crystal control signal when the ADF is in an operating mode and any shading number in a shading number range corresponding to an operating mode 2 is scheduled to be used; and
the liquid crystal control circuit comprises:
   a liquid crystal signal control circuit configured to generate a low-voltage high-frequency liquid crystal control signal and a first control voltage according to the control signal of the operating mode 1 output by the control device, or generate a high-voltage low-frequency liquid crystal control signal and a second control voltage according to the control signal of the operating mode 2 output by the control device; and
   a liquid crystal driving multiplexing circuit configured to receive the low-voltage high-frequency liquid crystal control signal and the first control voltage or the high-voltage low-frequency liquid crystal control signal and the second control voltage output by the liquid crystal signal control circuit, and the modulatable driving voltage output by the control device, generate a low-voltage high-frequency liquid crystal driving signal corresponding to the operating mode 1 or a high-voltage low-frequency liquid crystal driving signal corresponding to the operating mode 2, and output same to the two positive liquid crystal sheets, so that the two positive liquid crystal sheets receive the low-voltage high-frequency liquid crystal driving signal output by the liquid crystal driving multiplexing circuit, and are in the shading number that is in the shading number range corresponding to the operating mode 1 and is scheduled to be used, or receive the high-voltage low-frequency liquid crystal driving signal output by the liquid crystal driving multiplexing circuit, and are in the shading number that is in the shading number range corresponding to the operating mode 2 and is scheduled to be used.

According to a second aspect of the present disclosure, a control method of an auto-darkening filter (ADF) is provided, wherein the ADF comprises two positive liquid crystal sheets, a control device configured to output an original liquid crystal control signal and a modulatable driving voltage, and a liquid crystal control circuit configured to control the two positive liquid crystal sheets according to the original liquid crystal control signal received, the liquid crystal control circuit comprises a liquid crystal signal control circuit and a liquid crystal driving multiplexing circuit, and the control method comprises the following steps:
an operating mode generating step: enabling, by the control device, a liquid crystal signal control mode 1 to output a control signal of the operating mode 1 and the original liquid crystal control signal when the ADF is in an operating mode and any shading number in a shading number range corresponding to an operating mode 1 is scheduled to be used, or enabling, by the control device, a liquid crystal signal control mode 2 to output a control signal of the operating mode 2 and the original liquid crystal control signal when the ADF is in an operating mode and any shading number in a shading number range corresponding to an operating mode 2 is scheduled to be used;
a liquid crystal control signal generating step: generating, by the liquid crystal signal control circuit, a low-voltage high-frequency liquid crystal control signal and a first control voltage according to the control signal of the operating mode 1 output by the control device, or generating, by the liquid crystal signal control circuit, a high-voltage low-frequency liquid crystal control signal and a second control voltage according to the control signal of the operating mode 2 output by the control device;
a liquid crystal driving signal generating step: receiving, by the liquid crystal driving multiplexing circuit, the low-voltage high-frequency liquid crystal control signal and the first control voltage or the high-voltage low-frequency liquid crystal control signal and the second control voltage output by the liquid crystal signal control circuit and the modulatable driving voltage output by the control device, and generating a low-voltage high-frequency liquid crystal driving signal corresponding to the operating mode 1 or a high-voltage low-frequency liquid crystal driving signal corresponding to the operating mode 2, and outputting same to the two positive liquid crystal sheets; and
a liquid crystal driving step: receiving, by the two positive liquid crystal sheets, the low-voltage high-frequency liquid crystal driving signal output by the liquid crystal driving multiplexing circuit, and being in the shading number that is in the shading number range corresponding to the operating mode 1 and is scheduled to be used, or receiving, by the two positive liquid crystal sheets, the high-voltage low-frequency liquid crystal driving signal output by the liquid crystal driving multiplexing circuit, and being the shading number that is in the shading number range corresponding to the operating mode 2 and is scheduled to be used.

Preferably, the shading numbers in the shading number range corresponding to the operating mode 1 comprise DIN4-13, and the shading numbers in the shading number range corresponding to the operating mode 2 comprise DIN13-15. There are a plurality of application combination cases comprising but not limited to the following two combination cases: in a first combination case, the shading numbers in the shading number range corresponding to the operating mode 1 comprise DIN4-12, and the shading numbers in the shading number range corresponding to the operating mode 2 comprise DIN13-14; and in a second combination case, the shading numbers in the shading number range corresponding to the operating mode 1 comprise DIN4-13, and the shading numbers in the shading number range corresponding to the operating mode 2 comprise DIN14-15, wherein the shading number ranges that respectively correspond to the operating modes 1 and 2 are predetermined by the liquid crystal signal control circuit by adjusting circuit parameters.

Preferably, the low-voltage high-frequency liquid crystal control signal is a square wave with an operating voltage range of 4.5-5.5v and a frequency range of 10 Hz to 60 Hz, and the first control voltage is in a range of 4.5-5.5v. The high-voltage low-frequency liquid crystal control signal is a square wave or direct current voltage with an operating voltage range of 6-20v and a frequency range of 0.05 Hz to 20 Hz, and the second control voltage is in a range of 6-20v. The low-voltage high-frequency liquid crystal driving signal is a square wave with an operating voltage range of 1.2-5v and a frequency range of 10 Hz to 60 Hz. The high-voltage low-frequency liquid crystal driving signal is a square wave or direct current voltage with an operating voltage range of 6-20v and a frequency range of 0.05 Hz to 20 Hz.

According to the auto-darkening filter (ADF) and control method thereof provided in the present disclosure, the following improved technical effects are achieved: the ADF uses a liquid crystal box that only comprises two positive liquid crystal sheets but achieves the coverage of shading numbers of DIN4-15. Therefore, the ADF can achieve the coverage of the shading numbers of DIN14-15 (i.e. high shading numbers), and the cost, the size and the weight of the ADF are reduced, and the power consumption of the ADF is reduced in a case that the shading number is within DIN14-15 (i.e. being a high shading number).

### BRIEF DESCRIPTION OF THE DRAWINGS

FIG. 1 is a structural block diagram of an auto-darkening filter (ADF) according to a first embodiment of the present disclosure;

FIG. 2 is a structural block diagram of an auto-darkening filter (ADF) according to a second embodiment of the present disclosure;

FIG. 3 is a flowchart of a control method of an auto-darkening filter (ADF) according to a third embodiment of the present disclosure; and

FIG. 4 is a flowchart of a control method of an auto-darkening filter (ADF) according to a fourth embodiment of the present disclosure.

### DETAILED DESCRIPTION

To make those skilled in the art better understand the technical solution in the present disclosure, the technical solution in embodiments of the present disclosure will be clearly and completely described below in conjunction with the drawings. obviously, the described embodiments are only part, but not all, of the embodiments of the present disclosure. Based on the embodiments disclosed in the present application, all other embodiments obtained by those skilled in the art without making inventive effort shall fall within the scope of protection of the present application.

It needs to be noted that the terms “include” and “comprise” in the description, claims, and drawings of the present disclosure and any other variants thereof are intended to cover a non-exclusive inclusion. For example, a process, method, product or device that comprises a series of steps or units not only comprises those steps or units specified expressly, but also comprises other steps or units that are not specified expressly or are inherent to the process, system, product or device.

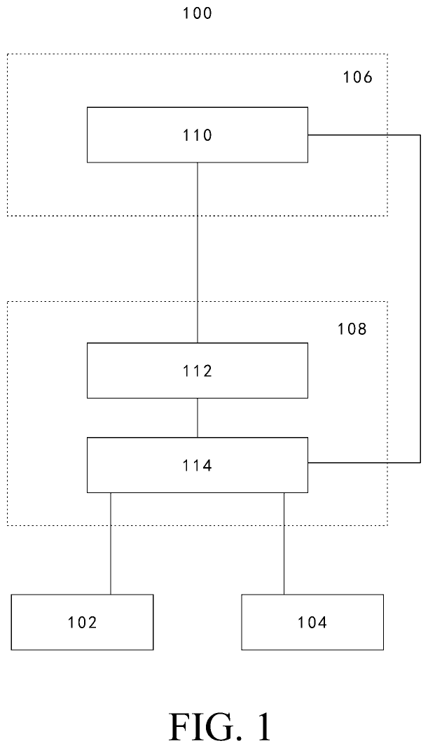

As shown in FIG. 1, an auto-darkening filter (ADF) 100 according to a first embodiment of the present disclosure is provided, The ADF 100 comprises two positive liquid crystal sheets 102 and 104, a control device 106 configured to output an original liquid crystal control signal and a modulatable driving voltage in a voltage range of 1.2-5 v, and a liquid crystal control circuit 108 configured to control the two positive liquid crystal sheets 102 and 104 according to the original liquid crystal control signal received.

The control device 106 comprises a microcontroller unit (MCU) 110, which is configured to enable a liquid crystal signal control mode 1 to output a control signal of the operating mode 1 and the original liquid crystal control signal when the ADF 100 is in an operating mode (comprising, but not limited to, a mode such as a welding mode or a cutting mode or a polishing mode, etc.) and any shading number in a shading number range of DIN4-12 (i.e. a shading number range corresponding to an operating mode 1) is scheduled to be used (DIN10 is scheduled to be used in present embodiment); or enable a liquid crystal signal control mode 2 to output a control signal of the operating mode 2 and the original liquid crystal control signal when the ADF 100 is in an operating mode and any shading number in a shading number range of DIN13-14 (i.e. a shading number range corresponding to an operating mode 2) is scheduled to be used (DIN14 is scheduled to be used in present embodiment).

The liquid crystal control circuit 108 comprises a liquid crystal signal control circuit 112 and a liquid crystal driving multiplexing circuit 114.

The liquid crystal signal control circuit 112 is configured to generate a low-voltage high-frequency liquid crystal control signal and a first control voltage according to the control signal of the operating mode 1 output by the MCU 110; or generate a high-voltage low-frequency liquid crystal control signal and a second control voltage according to the control signal of the operating mode 2 output by the MCU 110.

The low-voltage high-frequency liquid crystal control signal is a square wave with an operating voltage range of 4.5-5.5v (5v is selected in present embodiment) and a frequency range of 10 Hz-60 Hz, and the first control voltage is in a range of 4.5-5.5v (5v is selected in present embodiment). The high-voltage low-frequency liquid crystal control signal is a square wave or direct current voltage with an operating voltage range of 6-20v (12v is selected in present embodiment) and a frequency range of 0.05 Hz to 20 Hz, and the second control voltage is in a range of 6-20v (12v is selected in present embodiment).

The liquid crystal driving multiplexing circuit 114 is configured to receive the low-voltage high-frequency liquid crystal control signal and the first control voltage output by the liquid crystal signal control circuit 112 and the modulatable driving voltage (in a voltage range of 1.2-5 v) output by the MCU 110, and generate a low-voltage high-frequency liquid crystal driving signal corresponding to the operating mode 1 and output same to the two positive liquid crystal sheets 102 and 104, so that the two positive liquid crystal sheets 102 and 104 are in the shading number that is in the shading number range corresponding to the operating mode 1 and is scheduled to be used (i.e. DIN10 being scheduled to be used in present embodiment); or receive the high-voltage low-frequency liquid crystal control signal and the second control voltage and the modulatable driving voltage (in a voltage range of 1.2-5 v) output by the MCU 110, and generate a high-voltage low-frequency liquid crystal driving signal corresponding to the operating mode 2 and output same to the two positive liquid crystal sheets 102 and 104, so that the two positive liquid crystal sheets 102 and 104 are in the shading number that is in the shading number range corresponding to the operating mode 2 and is scheduled to be used (i.e. DIN14 being scheduled to be used in present embodiment).

The low-voltage high-frequency liquid crystal driving signal is a square wave with an operating voltage range of 1.2-5v and a frequency range of 10 Hz to 60 Hz. The high-voltage low-frequency liquid crystal driving signal is a square wave or direct current voltage with an operating voltage range of 6-20v (12v is selected in present embodiment) and a frequency range of 0.05 Hz to 20 Hz.

When the ADF 100 is in a standby state (i.e. a state such as a non-welding state or a non-cutting state or a non-polishing state, etc.), the two positive liquid crystal sheets 102 and 104 are not supplied with power and show a bright state. When the ADF 100 is in an operating state (comprising, but not limited to, a welding state or a cutting state or a polishing state, etc.), in the operating mode 1, the two positive liquid crystal sheets 102 and 104 are in the shading number (i.e. DIN10 in present embodiment) that is in the shading number range corresponding to the operating mode 1 (i.e. the shading number range of DIN4-12 in present embodiment) and is scheduled to be used, or in the operating mode 2, the two positive liquid crystal sheets 102 and 104 are in the shading number (i.e. DIN14 in present embodiment) that is in the shading number range corresponding to the operating mode 2 (i.e. the shading number range of DIN13-14 in present embodiment) and is scheduled to be used.

A variant of the first embodiment of the present disclosure is further provided (not shown), and a difference between the variant and the first embodiment only lies in that:

The control device 106 in the auto-darkening filter (ADF) 100 in the variant comprises a microcontroller unit (MCU) 110 being configured to: when the ADF 100 is in an operating mode (comprising, but not limited to, a mode such as a welding mode or a cutting mode or a polishing mode, etc.) and any shading number (DIN11 in the variant of the first embodiment) in a shading number range of DIN4-13 (i.e. a shading number range corresponding to an operating mode 1) is scheduled to be used, enable a liquid crystal signal control mode 1 to output a control signal of the operating mode 1 and the original liquid crystal control signal; or when the ADF 100 is in an operating mode and any shading number (DIN15 in the variant of the first embodiment) in a shading number range of DIN14-15 (i.e. a shading number range corresponding to an operating mode 2) is scheduled to be used, enable a liquid crystal signal control mode 2 to output a control signal of the operating mode 2 and the original liquid crystal control signal.

When the ADF 100 is in an operating state (comprising, but not limited to, a welding state or a cutting state or a polishing state, etc.), in the operating mode 1, the two positive liquid crystal sheets 102 and 104 are in the shading number (i.e. DIN11 in the variant of the first embodiment) that is in the shading number range corresponding to the operating mode 1 (i.e. the shading number range of DIN4-13 in the variant of the first embodiment) and is scheduled to be used; or in the operating mode 2, the two positive liquid crystal sheets 102 and 104 are in the shading number (i.e. DIN15 in the variant of the first embodiment) that is in the shading number range corresponding to the operating mode 2 (i.e. the shading number range of DIN14-15 in the variant of the first embodiment) and is scheduled to be used.

In the first embodiment or the variant thereof, the shading number range corresponding to the operating mode 1 (i.e. the shading number range of DIN4-12 or the shading number range of DIN4-13) and the shading number range corresponding to the operating mode 2 (i.e. the shading number range of DIN13-14 or the shading number range of DIN14-15) are predetermined by the liquid crystal signal control circuit 112 by adjusting circuit parameters. In the first embodiment, the shading number range covered by the ADF 100 is DIN4-14 (comprising the shading numbers of DIN4-12 and the shading numbers of DIN13-14). In the variant of the first embodiment, the shading number range covered by the ADF 100 is DIN4-15 (comprising the shading numbers of DIN4-13 and the shading numbers of DIN14-15).

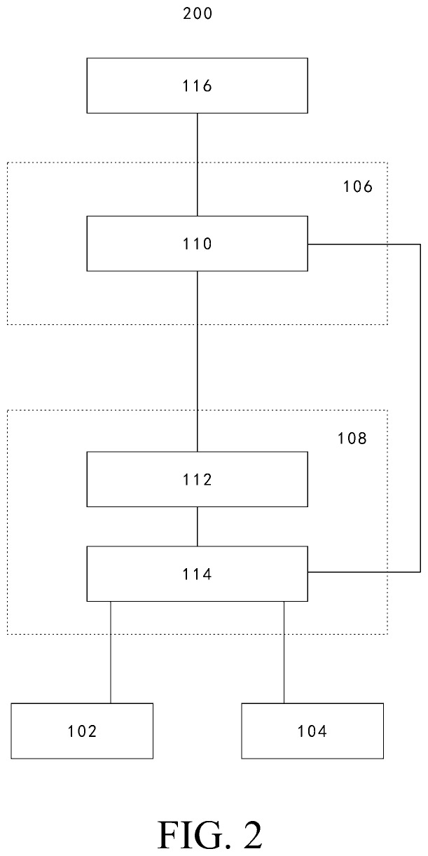

As shown in FIG. 2, an auto-darkening filter (ADF) 200 according to the second embodiment of the present disclosure is provided. The ADF 200 is basically similar to the ADF 100 according to the first embodiment of the present disclosure and the variant thereof, and a differences between the both lies in that: the ADF 200 further comprises a photoelectric sensor 116 being configured to detect whether the ADF 200 is in an operating state (comprising, but not limited to, a state such as a welding state or a cutting state or a polishing state, etc.) or not, and output a corresponding sensing signal to the MCU 110 (i.e. the control device 106).

When the ADF 200 is in a standby state (i.e. a state such as a non-welding state or a non-cutting state or a non-polishing state, etc.), the two positive liquid crystal sheets 102 and 104 are not supplied with power and show a bright state.

When the ADF 200 is in an operating mode (comprising, but not limited to, a mode such as a welding mode or a cutting mode or a polishing mode, etc.) and any shading number in a shading number range of DIN4-12 (corresponding to the first embodiment) is scheduled to be used or any shading number in a shading number range of DIN4-13 (corresponding to the variant of the first embodiment) is scheduled to be used, the photoelectric sensor 116 detects that the ADF 200 is not in an operating state(comprising, but not limited to, a state such as a welding state or a cutting state or a polishing state, etc.) and outputs a corresponding sensing signal to the MCU 110, the MCU 110 outputs the control signal of the operating mode 1 to the liquid crystal signal control circuit 112 and outputs the modulatable driving voltage to the liquid crystal driving multiplexing circuit 114. The liquid crystal signal control circuit 112 only outputs the first control voltage to the liquid crystal driving multiplexing circuit 114 but does not output the liquid crystal control signal. The liquid crystal driving multiplexing circuit 114 does not output the liquid crystal driving signal, so that the two positive liquid crystal sheets 102 and 104 are not driven and show a bright state.

When the ADF 200 is in an operating mode (comprising, but not limited to, a mode such as a welding mode or a cutting mode or a polishing mode, etc.) and any shading number in a shading number range of DIN4-12 (corresponding to the first embodiment) is scheduled to be used or any shading number in a shading number range of DIN4-13 (corresponding to the variant of the first embodiment) is scheduled to be used, the photoelectric sensor 116 detects that the ADF 200 is in an operating state (comprising, but not limited to, a state such as a welding state or a cutting state or a polishing state, etc.) and outputs a corresponding sensing signal to the MCU 110, the MCU 110 outputs the control signal of the operating mode 1 and the original liquid crystal control signal to the liquid crystal signal control circuit 112 and outputs the modulatable driving voltage to the liquid crystal driving multiplexing circuit 114. The liquid crystal signal control circuit 112 outputs the first control voltage and the low-voltage high-frequency liquid crystal control signal to the liquid crystal driving multiplexing circuit 114. The liquid crystal driving multiplexing circuit 114 generates the low-voltage high-frequency liquid crystal driving signal corresponding to the operating mode 1 and outputs same to the two positive liquid crystal sheets 102 and 104, so that the two positive liquid crystal sheets 102 and 104 are in the shading number that is in a shading number range of DIN4-12 and is scheduled to be used (corresponding to the first embodiment) or are in the shading number that is in a shading number range of DIN4-13 and is scheduled to be used (corresponding to the variant of the first embodiment).

When the ADF 200 is in an operating mode (comprising, but not limited to, a mode such as a welding mode or a cutting mode or a polishing mode, etc.) and any shading number in a shading number range of DIN13-14 (corresponding to the first embodiment) is scheduled to be used or any shading number in a shading number range of DIN14-15 (corresponding to the variant of the first embodiment) is scheduled to be used, the photoelectric sensor 116 detects that the ADF 200 is not in an operating state (comprising, but not limited to, a state such as a welding state or a cutting state or a polishing state, etc.) and outputs a corresponding sensing signal to the MCU 110, the MCU 110 outputs the control signal of the operating mode 2 to the liquid crystal signal control circuit 112 and outputs the modulatable driving voltage to the liquid crystal driving multiplexing circuit 114. the liquid crystal signal control circuit 112 only outputs the second control voltage to the liquid crystal driving multiplexing circuit 114 but does not output the liquid crystal control signal. The liquid crystal driving multiplexing circuit 114 does not output the liquid crystal driving signal, so that the two positive liquid crystal sheets 102 and 104 are not driven and show a bright state.

When the ADF 200 is in an operating mode (comprising, but not limited to, a mode such as a welding mode or a cutting mode or a polishing mode, etc.) and any shading number in a shading number range of DIN13-14 (corresponding to the first embodiment) is scheduled to be used or any shading number in a shading number range of DIN14-15 (corresponding to the variant of the first embodiment) is scheduled to be used, the photoelectric sensor 116 detects that the ADF 200 is in an operating state (comprising, but not limited to, a state such as a welding state or a cutting state or a polishing state, etc.) and outputs a corresponding sensing signal to the MCU 110, the MCU 110 outputs the control signal of the operating mode 2 and the original liquid crystal control signal to the liquid crystal signal control circuit 112 and outputs the modulatable driving voltage to the liquid crystal driving multiplexing circuit 114. The liquid crystal signal control circuit 112 outputs the second control voltage and the high-voltage low-frequency liquid crystal control signal to the liquid crystal driving multiplexing circuit 114. The liquid crystal driving multiplexing circuit 114 generates the high-voltage low-frequency liquid crystal driving signal corresponding to the operating mode 2 and outputs same to the two positive liquid crystal sheets 102 and 104, so that the two positive liquid crystal sheets 102 and 104 are in the shading number that is in the shading number range of DIN13-14 and is scheduled to be used (corresponding to the first embodiment) or are in the shading number that is in the shading number range of DIN14-15 and is scheduled to be used (corresponding to the variant of the first embodiment).

A variant of the second embodiment of the present disclosure is further provided (not shown), and a difference between the variant and the second embodiment only lies in that: the control device 106 in the ADF 200 in the variant further comprises an ADF operating parameter configuration control circuit (not shown) being configured to: when the ADF 200 is in a standby state, complete configuration of operating parameters of the ADF 200, wherein the operating parameters comprise, but are not limited to, a light shading degree, a sensitivity, a delay, etc. The microcontroller unit 110 is further configured to: when the ADF 200 is in a standby state, complete configuration of operating modes of the ADF 200, wherein the operating modes comprise, but are not limited to, a welding mode, a cutting mode, a polishing mode, etc.

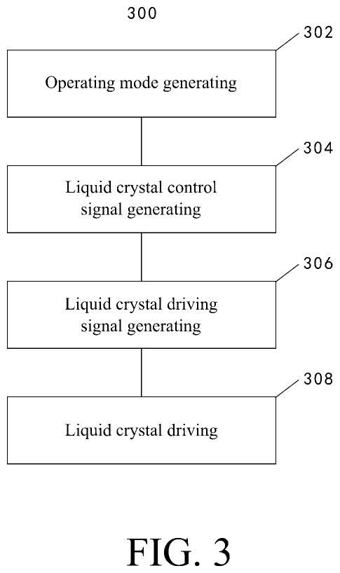

As shown in FIG. 3, a control method 300 of an auto-darkening filter (ADF) according to a third embodiment of the present disclosure is provided. The control method 300 is implemented by the ADF 100 according to the first embodiment of the present disclosure or the variant thereof, and comprises the operating mode generating step 302, a liquid crystal control signal generating step 304, a liquid crystal driving signal generating step 306, and a liquid crystal driving step 308.

In the operating mode generating step 302, when the ADF 100 is in an operating mode (comprising, but not limited to, a mode such as a welding mode or a cutting mode or a polishing mode, etc.) and any shading number in a shading number range of DIN4-12 (corresponding to the first embodiment) is scheduled to be used or any shading number in a shading number range of DIN4-13 (corresponding to the variant of the first embodiment) is scheduled to be used, the MCU 110 enables a liquid crystal signal control mode 1 to output a control signal of the operating mode 1 and the original liquid crystal control signal; or when the ADF 100 is in an operating mode (comprising, but not limited to, a mode such as a welding mode or a cutting mode or a polishing mode, etc.) and any shading number in a shading number range of DIN13-14 (corresponding to the first embodiment) is scheduled to be used or any shading number in a shading number range of DIN14-15 (corresponding to the variant of the first embodiment) is scheduled to be used, the MCU 110 enables a liquid crystal signal control mode 2 to output a control signal of the operating mode 2 and the original liquid crystal control signal.

In the liquid crystal control signal generating step 304, the liquid crystal signal control circuit 112 generates the low-voltage high-frequency liquid crystal control signal and the first control voltage according to the control signal of the operating mode 1 output by the MCU 110; or generates the high-voltage low-frequency liquid crystal control signal and the second control voltage according to the control signal of the operating mode 2 output by the microcontroller unit 110. The low-voltage high-frequency liquid crystal control signal is a square wave with an operating voltage range of 4.5-5.5v (5v is selected in present embodiment) and a frequency range of 10 Hz to 60 Hz, and the first control voltage is in a range of 4.5-5.5v (5v is selected in present embodiment). The high-voltage low-frequency liquid crystal control signal is a square wave or direct current voltage with an operating voltage range of 6-20v (12v is selected in present embodiment) and a frequency range of 0.05 Hz to 20 Hz, and the second control voltage is in a range of 6-20v (12v is selected in present embodiment).

In the liquid crystal driving signal generating step 306, the liquid crystal driving multiplexing circuit 114 receives the low-voltage high-frequency liquid crystal control signal and the first control voltage output by the liquid crystal signal control circuit 112 and the modulatable driving voltage (in a voltage range of 1.2v-5v) output by the MCU 110, and generates a low-voltage high-frequency liquid crystal driving signal corresponding to the operating mode 1 and outputs same to the two positive liquid crystal sheets 102 and 104; or receives the high-voltage low-frequency liquid crystal control signal and the second control voltage output by the liquid crystal signal control circuit 112 and the modulatable driving voltage (in a voltage range of 1.2v-5v) output by the MCU 110, and generates a high-voltage low-frequency liquid crystal driving signal corresponding to the operating mode 2 and outputs same to the two positive liquid crystal sheets 102 and 104. The low-voltage high-frequency liquid crystal driving signal is a square wave with an operating voltage range of 1.2-5v and a frequency range of 10 Hz to 60 Hz, and the high-voltage low-frequency liquid crystal driving signal is a square wave or direct current voltage with an operating voltage range of 6-20v (12v is selected in present embodiment) and a frequency range of 0.05 Hz to 20 Hz.

In the liquid crystal driving step 308, the two positive liquid crystal sheets 102 and 104 receive the low-voltage high-frequency liquid crystal driving signal output by the liquid crystal driving multiplexing circuit 114, and are in a shading number that is in the shading number range of DIN4-12 and is scheduled to be used (corresponding to the first embodiment) or in the shading number that is in a shading number range of DIN4-13 and is scheduled to be used (corresponding to the variant of the first embodiment), which corresponds to the control signal of the operating mode 1; or the two positive liquid crystal sheets 102 and 104 receive the high-voltage low-frequency liquid crystal driving signal output by the liquid crystal driving multiplexing circuit 114, and are in the shading number that is in the shading number range of DIN13-14 and is scheduled to be used (corresponding to the first embodiment) or are in the shading number that is in a shading number range of DIN14-15 and is scheduled to be used (corresponding to the variant of the first embodiment), which corresponds to the control signal of the operating mode 2.

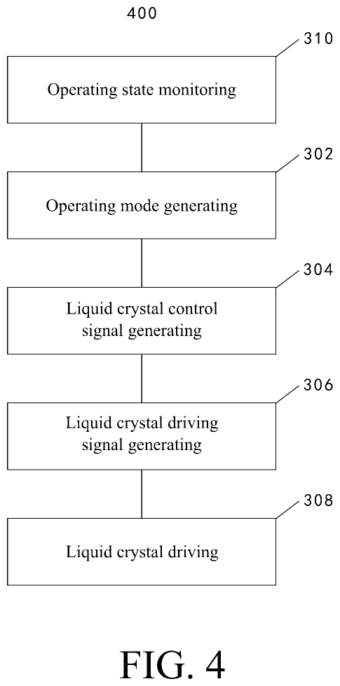

As shown in FIG. 4, a control method 400 of an auto-darkening filter (ADF) according to a fourth embodiment of the present disclosure is provided. The control method 400 is implemented by the ADF 200 in the second embodiment of the present disclosure, and is basically similar to the control method 300 in the third embodiment of the present disclosure. A difference between the control method 400 and the control method 300 lies in that: the control method 400 further comprises an operating state monitoring step 310 prior to the operating mode generating step 302.

In the operating state monitoring step 310, the photoelectric sensor 116 detects whether the ADF 200 is in an operating state (comprising, but not limited to, a state such as a welding state or a cutting state or a polishing state, etc.) or not, and outputs a corresponding sensing signal to the MCU 110.

When the ADF 200 is in a standby state (i.e. a non-welding state or a non-cutting state or a non-polishing state), the two positive liquid crystal sheets 102 and 104 are not supplied with power and show a bright state.

When the ADF 200 is in an operating mode (comprising, but not limited to, a mode such as a welding mode or a cutting mode or a polishing mode, etc.) and any shading number in a shading number range of DIN4-12 (corresponding to the first embodiment) is scheduled to be used or any shading number in a shading number range of DIN4-13 (corresponding to the variant of the first embodiment) is scheduled to be used, in the operating state monitoring step 310, the photoelectric sensor 116 detects that the ADF 200 is not in an operating state (comprising, but not limited to, a state such as a welding state or a cutting state or a polishing state, etc.) and outputs a corresponding sensing signal to the MCU 110. In the operating mode generation step 302, the microcontroller unit 110 outputs the control signal of the operating mode 1 to the liquid crystal signal control circuit 112 and outputs the modulatable driving voltage to the liquid crystal driving multiplexing circuit 114. In the liquid crystal control signal generating step 304, the liquid crystal signal control circuit 112 only outputs the first control voltage to the liquid crystal driving multiplexing circuit 114 but does not output the liquid crystal control signal. In the liquid crystal driving signal generating step 306, the liquid crystal driving multiplexing circuit 114 does not output the liquid crystal driving signal. In the liquid crystal driving step 308, the two positive liquid crystal sheets 102 and 104 are not driven and show a bright state.

When the ADF 200 is in an operating mode (comprising, but not limited to, a mode such as a welding mode or a cutting mode or a polishing mode, etc.) and any shading number in a shading number range of DIN4-12 (corresponding to the first embodiment) is scheduled to be used or any shading number in a shading number range of DIN4-13 (corresponding to the variant of the first embodiment) is scheduled to be used, in the operating state monitoring step 310, the photoelectric sensor 116 detects that the ADF 200 is in an operating state (comprising, but not limited to, a state such as a welding state or a cutting state or a polishing state, etc.) and outputs a corresponding sensing signal to the MCU 110. In the operating mode generating step 302, the MCU 110 outputs the control signal of the operating mode 1 and the original liquid crystal control signal to the liquid crystal signal control circuit 112 and outputs the modulatable driving voltage to the liquid crystal driving multiplexing circuit 114. In the liquid crystal control signal generating step 304, the liquid crystal signal control circuit 112 outputs the first control voltage and the low-voltage high-frequency liquid crystal control signal to the liquid crystal driving multiplexing circuit 114. In the liquid crystal driving signal generating step 306, the liquid crystal driving multiplexing circuit 114 generates the low-voltage high-frequency liquid crystal driving signal corresponding to the operating mode 1 and outputs same to the two positive liquid crystal sheets 102 and 104, so that the two positive liquid crystal sheets 102 and 104 are in the shading number that is in a shading number range of DIN4-12 and is scheduled to be used (corresponding to the first embodiment) or in the shading number that is in a shading number range of DIN4-13 and is scheduled to be used (corresponding to the variant of the first embodiment). In the liquid crystal driving step 308, the two positive liquid crystal sheets 102 and 104 are in the shading number that is in the shading number range of DIN4-12 and is scheduled to be used (corresponding to the first embodiment) or are in the shading number that is in a shading number range of DIN4-13 and is scheduled to be used (corresponding to the variant of the first embodiment).

When the ADF 200 is in an operating mode (comprising, but not limited to, a mode such as a welding mode or a cutting mode or a polishing mode, etc.) and any shading number in a shading number range of DIN13-14 (corresponding to the first embodiment) is scheduled to be used or any shading number in a shading number range of DIN14-15 (corresponding to the variant of the first embodiment) is scheduled to be used, in the operating state monitoring step 310, the photoelectric sensor 116 detects that the ADF 200 is not in an operating state (comprising, but not limited to, a state such as a welding state or a cutting state or a polishing state, etc.) and outputs a corresponding sensing signal to the MCU 110. In the operating mode generating step 302, the MCU 110 outputs the control signal of the operating mode 2 to the liquid crystal signal control circuit 112 and outputs the modulatable driving voltage to the liquid crystal driving multiplexing circuit 114. In the liquid crystal control signal generating step 304, the liquid crystal signal control circuit 112 only outputs the second control voltage to the liquid crystal driving multiplexing circuit 114 but does not output the liquid crystal control signal. In the liquid crystal driving signal generating step 306, the liquid crystal driving multiplexing circuit 114 does not output the liquid crystal driving signal. In the liquid crystal driving step 308, the two positive liquid crystal sheets 102 and 104 are not driven and show a bright state.

When the ADF 200 is in an operating mode (comprising, but not limited to, a mode such as a welding mode or a cutting mode or a polishing mode, etc.) and any shading number in a shading number range of DIN13-14 (corresponding to the first embodiment) is scheduled to be used or any shading number in a shading number range of DIN14-15 (corresponding to the variant of the first embodiment) is scheduled to be used, in the operating state monitoring step 310, the photoelectric sensor 116 detects that the ADF 200 is in an operating state (comprising, but not limited to, a state such as a welding state or a cutting state or a polishing state, etc.) and outputs a corresponding sensing signal to the MCU 110. In the operating mode generating step 302, the MCU 110 outputs the control signal of the operating mode 2 and the original liquid crystal control signal to the liquid crystal signal control circuit 112 and outputs the modulatable driving voltage to the liquid crystal driving multiplexing circuit 114. In the liquid crystal control signal generating step 304, the liquid crystal signal control circuit 112 outputs the second control voltage and the high-voltage low-frequency liquid crystal control signal to the liquid crystal driving multiplexing circuit 114. In the liquid crystal driving signal generating step 306, the liquid crystal driving multiplexing circuit 114 generates the high-voltage low-frequency liquid crystal driving signal corresponding to the operating mode 2 and outputs same to the two positive liquid crystal sheets 102 and 104, so that the two positive liquid crystal sheets 102 and 104 are in the shading number that is in a shading number range of DIN13-14 and is scheduled to be used (corresponding to the first embodiment) or are in the shading number that is in a shading number range of DIN14-15 and is scheduled to be used (corresponding to the variant of the first embodiment). In the liquid crystal driving step 308, the two positive liquid crystal sheets 102 and 104 are in the shading number that is in a shading number range of DIN13-14 and is scheduled to be used (corresponding to the first embodiment) or are in the shading number that is in a shading number range of DIN14-15 and is scheduled to be used (corresponding to the variant of the first embodiment).

In a variant (not shown) of the fourth embodiment of the present disclosure, the control device 106 in the ADF 200 further comprises an ADF operating parameter configuration control circuit (not shown). The control method 300 in the variant further comprises an operating parameter configuring step (not shown) prior to the operating state monitoring step 310. In the operating parameter configuring step, the ADF operating parameter configuration control circuit completes configuration of operating parameters of the ADF 200 when the ADF 200 is in a standby state, wherein the operating parameters comprise but are not limited to, a light shading degree, a sensitivity, a time delay, etc. In the operating mode generating step 302, the MCU 110 further completes configuration of operating modes of the ADF 200 in a standby state, wherein the operating modes comprise, but are not limited to, a polishing mode, a welding mode, a cutting mode, etc.

According to the auto-darkening filter (ADF) and control method thereof provided in the embodiments of the present disclosure, the ADF uses a liquid crystal box only comprising two positive liquid crystal sheets and achieves the coverage of a shading number range of DIN4-15. Further, the ADF can achieve the coverage of the shading numbers of DIN14-15 (i.e. comprising high shading numbers). In addition, the cost, the size and the weight of the ADF can be reduced, and the power consumption of the ADF can be reduced when the shading number is within DIN14-15 (i.e. being a high shading number).

It may be understood that the above specific implementations are merely example implementations for describing the principles of the present disclosure, and do not constitute a limitation to the scope of protection of the present disclosure. It should be understood by those skilled in the art that various modifications, combinations, sub-combinations, and substitutions may be made depending on application requirements and other factors. Any modifications, equivalent replacements, improvements, etc. made within the spirit and principles of the present disclosure should be encompassed in the scope of protection of the present disclosure.

1. An auto-darkening filter (ADF), comprising:
two positive liquid crystal sheets;
a control device configured to output an original liquid crystal control signal and a modulatable driving voltage; and
a liquid crystal control circuit configured to control the two positive liquid crystal sheets according to the original liquid crystal control signal received,
wherein
the control device is further configured to enable a liquid crystal signal control mode 1 to output a control signal of an operating mode 1 and the original liquid crystal control signal when the ADF is in an operating mode and any shading number in a shading number range corresponding to the operating mode 1 is scheduled to be used, or enable a liquid crystal signal control mode 2 to output a control signal of an operating mode 2 and the original liquid crystal control signal when the ADF is in an operating mode and any shading number in a shading number range corresponding to the operating mode 2 is scheduled to be used; and
wherein the liquid crystal control circuit comprises:
a liquid crystal signal control circuit configured to generate a low-voltage high-frequency liquid crystal control signal and a first control voltage according to the control signal of the operating mode 1 output by the control device, or generate a high-voltage low-frequency liquid crystal control signal and a second control voltage according to the control signal of the operating mode 2 output by the control device; and
a liquid crystal driving multiplexing circuit configured to receive the low-voltage high-frequency liquid crystal control signal and the first control voltage or the high-voltage low-frequency liquid crystal control signal and the second control voltage output by the liquid crystal signal control circuit, and the modulatable driving voltage output by the control device, generate a low-voltage high-frequency liquid crystal driving signal corresponding to the operating mode 1 or a high-voltage low-frequency liquid crystal driving signal corresponding to the operating mode 2, and output same to the two positive liquid crystal sheets, so that the two positive liquid crystal sheets receive the low-voltage high-frequency liquid crystal driving signal output by the liquid crystal driving multiplexing circuit, and are in the shading number that is in the shading number range corresponding to the operating mode 1 and is scheduled to be used, or receive the high-voltage low-frequency liquid crystal driving signal output by the liquid crystal driving multiplexing circuit, and are in the shading number that is in the shading number range corresponding to the operating mode 2 and is scheduled to be used.

2. The auto-darkening filter according to claim 1, wherein shading numbers in the shading number range corresponding to the operating mode 1 comprise DIN4-13, and shading numbers in the shading number range corresponding to the operating mode 2 comprise DIN13-15, there are a plurality of application cases comprising the following two application combination cases:
in a first case, the shading numbers in the shading number range corresponding to the operating mode 1 comprise DIN4-12, and the shading numbers in the shading number range corresponding to the operating mode 2 comprise DIN13-14; and
in a second case, the shading numbers in the shading number range corresponding to the operating mode 1 comprise DIN4-13, and the shading numbers in the shading number range corresponding to the operating mode 2 comprise DIN14-15,
wherein the shading number ranges that respectively correspond to the operating modes 1 and 2 are predetermined by the liquid crystal signal control circuit by adjusting circuit parameters.

3. The auto-darkening filter according to claim 1, wherein the low-voltage high-frequency liquid crystal control signal is a square wave with an operating voltage range of 4.5-5.5v and a frequency range of 10 Hz to 60 Hz, and the first control voltage is in a range of 4.5-5.5v; and the high-voltage low-frequency liquid crystal control signal is a square wave or direct current voltage with an operating voltage range of 6-20v and a frequency range of 0.05 Hz to 20 Hz, and the second control voltage is in a range of 6-20v; or
the low-voltage high-frequency liquid crystal driving signal is a square wave with an operating voltage range of 1.2-5v and a frequency range of 10 Hz to 60 Hz; and the high-voltage low-frequency liquid crystal driving signal is a square wave or direct current voltage with an operating voltage range of 6-20v and a frequency range of 0.05 Hz to 20 Hz.

4. The auto-darkening filter according to claim 1, wherein the ADF further comprises a photoelectric sensor configured to detect whether the ADF is in an operating state or not, and output a corresponding sensing signal to the control device.

5. The auto-darkening filter according to claim 4, wherein when the ADF is in an operating mode and any shading number in the shading number range corresponding to the operating mode 1 is scheduled to be used, the photoelectric sensor detects that the ADF is not in an operating state and outputs the corresponding sensing signal to the control device, the control device outputs the control signal of the operating mode 1 to the liquid crystal signal control circuit and outputs the modulatable driving voltage to the liquid crystal driving multiplexing circuit, the liquid crystal signal control circuit only outputs the first control voltage to the liquid crystal driving multiplexing circuit but does not output the liquid crystal control signal, and the liquid crystal driving multiplexing circuit does not output the liquid crystal driving signal, so that the two positive liquid crystal sheets are not driven and show a bright state.

6. The auto-darkening filter according to claim 4, wherein when the ADF is in an operating mode and any shading number in the shading number range corresponding to the operating mode 1 is scheduled to be used, the photoelectric sensor detects that the ADF is in an operating state and outputs the corresponding sensing signal to the control device, the control device outputs the control signal of the operating mode 1 and the original liquid crystal control signal to the liquid crystal signal control circuit and outputs the modulatable driving voltage to the liquid crystal driving multiplexing circuit, the liquid crystal signal control circuit outputs the first control voltage and the low-voltage high-frequency liquid crystal control signal to the liquid crystal driving multiplexing circuit, and the liquid crystal driving multiplexing circuit generates the low-voltage high-frequency liquid crystal driving signal corresponding to the operating mode 1 and outputs same to the two positive liquid crystal sheets, so that the two positive liquid crystal sheets are in the shading number that is in the shading number range corresponding to the operating mode 1 and is scheduled to be used.

7. The auto-darkening filter according to claim 4, wherein when the ADF is in an operating mode and any shading number in the shading number range corresponding to the operating mode 2 is scheduled to be used, the photoelectric sensor detects that the ADF is not in an operating state and outputs the corresponding sensing signal to the control device, the control device outputs the control signal of the operating mode 2 to the liquid crystal signal control circuit and outputs the modulatable driving voltage to the liquid crystal driving multiplexing circuit, the liquid crystal signal control circuit only outputs the second control voltage to the liquid crystal driving multiplexing circuit but does not output the liquid crystal control signal, and the liquid crystal driving multiplexing circuit does not output the liquid crystal driving signal, so that the two positive liquid crystal sheets are not driven and show a bright state.

8. The auto-darkening filter according to claim 4, wherein when the ADF is in an operating mode and any shading number in the shading number range corresponding to the operating mode 2 is scheduled to be used, the photoelectric sensor detects that the ADF is in an operating state and outputs the corresponding sensing signal to the control device, the control device outputs the control signal of the operating mode 2 and the original liquid crystal control signal to the liquid crystal signal control circuit and outputs the modulatable driving voltage to the liquid crystal driving multiplexing circuit, the liquid crystal signal control circuit outputs the second control voltage and the high-voltage low-frequency liquid crystal control signal to the liquid crystal driving multiplexing circuit, and the liquid crystal driving multiplexing circuit generates the high-voltage low-frequency liquid crystal driving signal corresponding to the operating mode 2 and outputs same to the two positive liquid crystal sheets, so that the two positive liquid crystal sheets are in the shading number that is in the shading number range corresponding to the operating mode 2 and is scheduled to be used.

9. A control method of an auto-darkening filter (ADF), wherein the ADF comprises two positive liquid crystal sheets, a control device configured to output an original liquid crystal control signal and a modulatable driving voltage, and a liquid crystal control circuit configured to control the two positive liquid crystal sheets according to the original liquid crystal control signal received, the liquid crystal control circuit comprises a liquid crystal signal control circuit and a liquid crystal driving multiplexing circuit, and the control method comprises the following steps:
an operating mode generating step: enabling, by the control device, a liquid crystal signal control mode 1 to output a control signal of an operating mode 1 and the original liquid crystal control signal when the ADF is in an operating mode and any shading number in a shading number range corresponding to the operating mode 1 is scheduled to be used, or enabling, by the control device, a liquid crystal signal control mode 2 to output a control signal of an operating mode 2 and the original liquid crystal control signal when the ADF is in an operating mode and any shading number in a shading number range corresponding to the operating mode 2 is scheduled to be used;
a liquid crystal control signal generating step: generating, by the liquid crystal signal control circuit, a low-voltage high-frequency liquid crystal control signal and a first control voltage according to the control signal of the operating mode 1 output by the control device, or generating, by the liquid crystal signal control circuit, a high-voltage low-frequency liquid crystal control signal and a second control voltage according to the control signal of the operating mode 2 output by the control device;
a liquid crystal driving signal generating step: receiving, by the liquid crystal driving multiplexing circuit, the low-voltage high-frequency liquid crystal control signal and the first control voltage or the high-voltage low-frequency liquid crystal control signal and the second control voltage output by the liquid crystal signal control circuit and the modulatable driving voltage output by the control device, and generating a low-voltage high-frequency liquid crystal driving signal corresponding to the operating mode 1 or a high-voltage low-frequency liquid crystal driving signal corresponding to the operating mode 2, and outputting same to the two positive liquid crystal sheets; and
a liquid crystal driving step: receiving, by the two positive liquid crystal sheets, the low-voltage high-frequency liquid crystal driving signal output by the liquid crystal driving multiplexing circuit, and being in the shading number that is in the shading number range corresponding to the operating mode 1 and is scheduled to be used, or receiving, by the two positive liquid crystal sheets, the high-voltage low-frequency liquid crystal driving signal output by the liquid crystal driving multiplexing circuit, and being the shading number that is in the shading number range corresponding to the operating mode 2 and is scheduled to be used.

10. The control method according to claim 9, wherein the shading numbers in the shading number range corresponding to the operating mode 1 comprise DIN4-13, and the shading numbers in the shading number range corresponding to the operating mode 2 comprise DIN13-15, there are a plurality of application cases comprising the following two combination cases:
in a first case, the shading numbers in the shading number range corresponding to the operating mode 1 comprise DIN4-12, and the shading numbers in the shading number range corresponding to the operating mode 2 comprise DIN13-14; and
in a second case, the shading numbers in the shading number range corresponding to the operating mode 1 comprise DIN4-13, and the shading numbers in the shading number range corresponding to the operating mode 2 comprise DIN14-15,
wherein the shading number ranges that respectively correspond to the operating modes 1 and 2 are predetermined by the liquid crystal signal control circuit by adjusting circuit parameters.

11. The control method according to claim wherein the low-voltage high-frequency liquid crystal control signal is a square wave with an operating voltage range of 4.5-5.5v and a frequency range of 10 Hz to 60 Hz, and the first control voltage is in a range of 4.5-5.5v; and the high-voltage low-frequency liquid crystal control signal is a square wave or direct current voltage with an operating voltage range of 6-20v and a frequency range of 0.05 Hz to 20 Hz, and the second control voltage is in a range of 6-20v; or
the low-voltage high-frequency liquid crystal driving signal is a square wave with an operating voltage range of 1.2-5v and a frequency range of 10 Hz to 60 Hz; and the high-voltage low-frequency liquid crystal driving signal is a square wave or direct current voltage with an operating voltage range of 6-20v and a frequency range of 0.05 Hz to 20 Hz.

12. The control method according to claim 9, wherein the ADF further comprises a photoelectric sensor, the control method further comprises an operating state monitoring step, prior to said operating mode generating step, in which the photoelectric sensor detects whether the ADF is in an operating state or not, and outputs a corresponding sensing signal to the control device.

13. The control method according to claim 12, wherein when the ADF is in an operating mode and any shading number in the shading number range corresponding to the operating mode 1 is scheduled to be used,
in the operating state monitoring step, the photoelectric sensor detects that the ADF is not in an operating state and outputs the corresponding sensing signal to the control device;
in the operating mode generating step, the control device outputs the control signal of the operating mode 1 to the liquid crystal signal control circuit and outputs the modulatable driving voltage to the liquid crystal driving multiplexing circuit;
in the liquid crystal control signal generating step, the liquid crystal signal control circuit only outputs the first control voltage to the liquid crystal driving multiplexing circuit but does not output the liquid crystal control signal;
in the liquid crystal driving signal generating step, the liquid crystal driving multiplexing circuit does not output the liquid crystal driving signal; and
in the liquid crystal driving step, the two positive liquid crystal sheets are not driven and show a bright state.

14. The control method according to claim 12, wherein when the ADF is in an operating mode and any shading number in the shading number range corresponding to the operating mode 1 is scheduled to be used,
in the operating state monitoring step, the photoelectric sensor detects that the ADF is in an operating state and outputs the corresponding sensing signal to the control device;
in the operating mode generating step, the control device outputs the control signal of the operating mode 1 and the original liquid crystal control signal to the liquid crystal signal control circuit and outputs the modulatable driving voltage to the liquid crystal driving multiplexing circuit;
in the liquid crystal control signal generating step, the liquid crystal signal control circuit outputs the first control voltage and the low-voltage high-frequency liquid crystal control signal to the liquid crystal driving multiplexing circuit;
in the liquid crystal driving signal generating step, the liquid crystal driving multiplexing circuit generates the low-voltage high-frequency liquid crystal driving signal corresponding to the operating mode 1 and outputs same to the two positive liquid crystal sheets, so that the two positive liquid crystal sheets are in the shading number that is in the shading number range corresponding to the operating mode 1 and is scheduled to be used; and
in the liquid crystal driving step, the two positive liquid crystal sheets are in the shading number that is in the shading number range corresponding to the operating mode 1 and is scheduled to be used.

15. The control method according to claim 12, wherein when the ADF is in an operating mode and any shading number in the shading number range corresponding to the operating mode 2 is scheduled to be used,
in the operating state monitoring step, the photoelectric sensor detects that the ADF is not in an operating state and outputs the corresponding sensing signal to the control device;
in the operating mode generating step, the control device outputs the control signal of the operating mode 2 to the liquid crystal signal control circuit and outputs the modulatable driving voltage to the liquid crystal driving multiplexing circuit;
in the liquid crystal control signal generating step, the liquid crystal signal control circuit only outputs the second control voltage to the liquid crystal driving multiplexing circuit but does not output the liquid crystal control signal;
in the liquid crystal driving signal generating step, the liquid crystal driving multiplexing circuit does not output the liquid crystal driving signal; and
in the liquid crystal driving step, the two positive liquid crystal sheets are not driven and show a bright state.

16. The control method according to claim 12, wherein when the ADF is in an operating mode and any shading number in the shading number range corresponding to the operating mode 2 is scheduled to be used,
in the operating state monitoring step, the photoelectric sensor detects that the ADF is in an operating state and outputs the corresponding sensing signal to the control device;
in the operating mode generating step, the control device outputs the control signal of the operating mode 2 and the original liquid crystal control signal to the liquid crystal signal control circuit and outputs the modulatable driving voltage to the liquid crystal driving multiplexing circuit;
in the liquid crystal control signal generating step, the liquid crystal signal control circuit outputs the second control voltage and the high-voltage low-frequency liquid crystal control signal to the liquid crystal driving multiplexing circuit;
in the liquid crystal driving signal generating step, the liquid crystal driving multiplexing circuit generates the high-voltage low-frequency liquid crystal driving signal corresponding to the operating mode 2 and outputs same to the two positive liquid crystal sheets, so that the two positive liquid crystal sheets are in the shading number that is in the shading number range corresponding to the operating mode 2 and is scheduled to be used; and
in the liquid crystal driving step, the two positive liquid crystal sheets are in the shading number that is in the shading number range corresponding to the operating mode 2 and is scheduled to be used.
